(19) United States
(12) Patent Application Publication
(10) Pub. No.: US 2022/0203898 A1
(43) Pub. Date: Jun. 30, 2022

(54) VEHICLE SIDE MIRROR WITH VIDEO DISPLAY AND AUTOMATIC CAMERA SYSTEM

(71) Applicant: Larry Warren, Saint Matthews, SC (US)

(72) Inventor: Larry Warren, Saint Matthews, SC (US)

(21) Appl. No.: 17/211,421

(22) Filed: Mar. 24, 2021

Related U.S. Application Data
(60) Provisional application No. 63/131,618, filed on Dec. 29, 2020.

(51) Int. Cl. B60R 1/08; B60R 1/072; B60R 1/12; B60R 11/04; H04N 5/225; G01S 13/931

(52) U.S. Cl. CPC B60R 1/081; B60R 1/072; B60R 1/1207; B60R 11/04; B60R 2011/0033; H04N 5/2252; G01S 13/931; B60R 2001/1223; B60R 2001/1253; H04N 5/2254

(57) ABSTRACT

An automatic side mirror camera system for a vehicle where the camera system eliminates blind spots. The vehicle side mirror has a built-in video display portion, enabling drivers to see both the mirror and the camera display at the same time. A camera is housed inside the side mirror housing, and turns on automatically when the turn signal is turned on by the driver. The automatic side mirror camera system may also be connected to a backup camera, and automatically display the view from the backup camera whenever the vehicle is in reverse. The automatic side mirror camera system may also be connected to one or more proximity sensors located on the vehicle so that the camera display turns on automatically if one of the proximity sensors is triggered.

### CROSS-REFERENCE TO RELATED APPLICATION

The present application is related to and claims priority from prior provisional application Ser. No. 63/131618, filed Dec. 29, 2020, the entire application of which is incorporated herein by reference.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The presently claimed invention relates generally to the field of vehicle camera systems. More specifically, the invention is an automatic side mirror camera system for a vehicle, structure and arranged to eliminate blind spots, with a built in video display on the side mirror.

### 2. Description of the Related Art

A vehicle's blind spot is one or more areas around a vehicle that cannot be directly observed by the driver while at the vehicle's controls, under existing circumstances. Many types of vehicles have blind spots, including aircraft, cars, motorboats, sailboats, and trucks. There are only a few types of transportation that do not have blind spots, such as horses, bicycles, and motorcycles. Proper adjustment of mirrors and other technical solutions such as blind spot cameras are currently used to reduce or eliminate vehicle blind spots. However, not all cars are built with the necessary video display system inside the car, especially older models.

Various attempts have been made to solve the above-mentioned problems such as those found in U.S. Pat. and Pub. Nos. 6,954,152; 9,216,689; 10,195,994; 2009/0066836; 2013/0155236; 2018/0015879; 2018/0290594. This art is representative of blind spot cameras. None of the above inventions and patents, taken either singly or in combination, is seen to describe the invention as claimed.

Ideally, a blind spot camera system should provide an automatic blind spot camera that would operate reliably and be manufactured at a modest expense and be installable in older vehicle models as well as newly manufactured models. Thus, a need exists for a reliable smart signal automatic side mirror camera system, structure and arranged to eliminate vehicle blind spots, with a built in video display portion in the side mirror, to avoid the above-mentioned problems.

### BRIEF SUMMARY OF THE INVENTION

In view of the foregoing disadvantages inherent in the known blind spot camera systems art, the presently claimed invention provides a novel smart signal automatic vehicle blind spot camera. The general purpose of the present invention, which will be described subsequently in greater detail is to provide an automatic side mirror camera system for a vehicle where the camera system is structured and arranged to eliminate blind spots, and the side mirror has a built-in video display portion, enabling drivers to see both the mirror and the camera display at the same time.

The presently claimed smart blind spot camera system is a turn signal system with built-in camera that automatically activate when the turn signal is on. Side mirrors can't completely eliminate blind spots, forcing drivers to constantly turn their heads when changing lanes, turning, parking, and many other necessary driving activities. As the presently claimed smart blind spot camera system automatically activates when the turn signal is on, drivers can see to the side and behind the vehicle without taking their eyes off the road. This makes driving significantly safer.

Additionally, as the side mirror has a built-in video display portion, the driver can see both what is in the mirror, and what is displayed by the camera, at the same time, without having to shift their gaze. These side mirrors are installable on vehicles that were manufactured without an internal video display monitor, and are therefore useful for older models of vehicle as well as newly manufactured vehicles.

The presently claimed invention holds significant improvements and serves as an improved smart blind spot camera system is a turn signal system with built-in camera that automatically activate when the turn signal is on. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention that are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures that accompany the written portion of this specification illustrate embodiments and method(s) of use for the present invention, a vehicle side mirror with video display and automatic camera system, constructed and operative according to the teachings of the presently claimed invention.

FIG. 1 shows a perspective view illustrating a vehicle side mirror with video display and automatic camera system, according to an embodiment of the presently claimed invention.

FIG. 2 is a perspective view illustrating a vehicle side mirror with video display and automatic camera system, according to an embodiment of the presently claimed invention of FIG. 1.

FIG. 3 is a perspective view illustrating a vehicle side mirror with video display and automatic camera system, according to an embodiment of the presently claimed invention of FIG. 1.

FIG. 4 is a perspective view illustrating a vehicle with a vehicle side mirror with video display and automatic camera system, according to an embodiment of the presently claimed invention of FIG. 1

The various embodiments of the present invention will hereinafter be described in conjunction with the appended drawings, wherein like designations denote like elements.

### DETAILED DESCRIPTION

As discussed above, embodiments of the presently claimed invention relate to a smart signal automatic vehicle blind spot camera, and more particularly to an automatic side mirror camera system for a vehicle where the camera system is structured and arranged to improve the vehicle's blind spots, and the side mirror has a built-in video display portion.

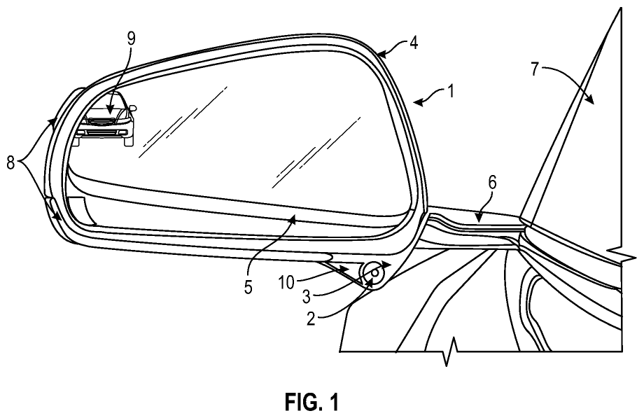

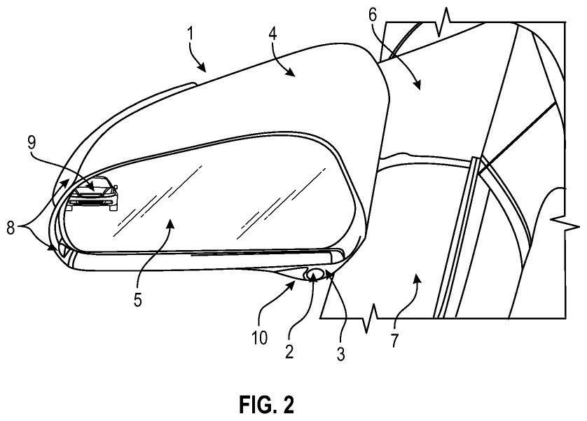

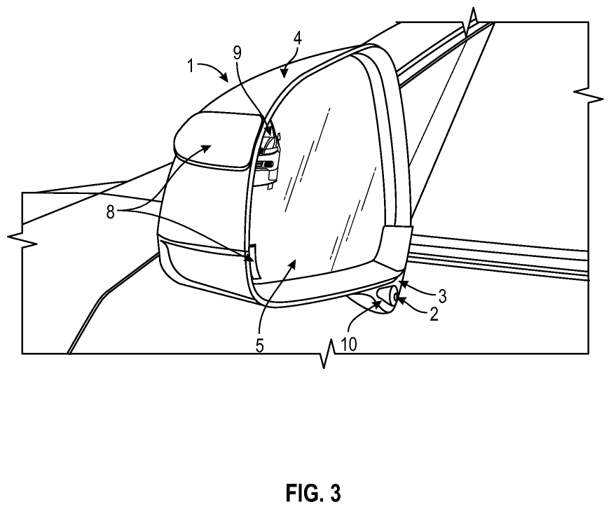

Referring to the drawings by numerals of reference there is shown in FIGS. 1-3, a vehicle side mirror 1 with a built-in camera 2 operably located to capture images from the vehicles blind spot. The camera 2 is housed in a camera compartment 3 in the mirror housing 4, which surrounds and protects the mirror 5 and together with the mirror 5 forms the vehicle side mirror 1. The side mirror 1 is attached to the vehicle 7 by an arm 6. The mirror housing 4 includes one or more built-in signal blinkers and warning indicators 8a, 8b.

A video display portion 9 is also located within the mirror housing 4, with the mirror 5 shaped around the video display portion 9 so that a driver can view both the mirror 5 and the video display portion 9 at the same time. The video display portion 9 is connected to the camera 2 to display the images captured by the camera thereon. The camera 2 and video display portion 9 are also connected to the vehicle's 7 turn signal so that the camera 2 and video display portion 9 automatically turn on when a turn signal indicator 8 is activated.

The camera 2 is adjustable so the driver can view different angles around the vehicle 7, ensuring all blind spots are covered by the camera 2. The camera is connected to one or more proximity sensors 10 that detects an obstacle or another vehicle in the blind spot and automatically turns on the camera 2 and video display portion 9. The proximity sensor(s) 10 may also include a radar detector.

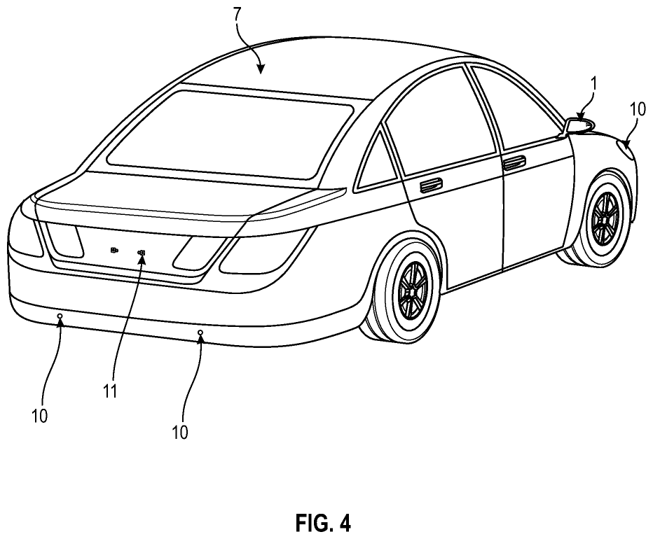

As shown in FIG. 4, the video display portion 9 may additionally be connected to display images from a backup camera 11 located at the back of the vehicle 7. The vehicle may have additional proximity sensor(s) 10 located around the vehicle 7 as needed to ensure all blind spots are covered by the camera 2 and any backup camera 11.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

1. An automatic blind spot mirror and camera system for vehicles, comprising:
a. a mirror having a back side and a front reflective side;
b. a mirror housing having
i. one or more built-in signal blinkers having one or more light sources and a plastic covering, wherein the one or more built-in signal blinkers are operably connectable to a vehicle to receive an on signal and an off signal from the vehicle and blink the one or more light sources while receiving the on signal;
ii. a camera compartment having a lens opening, wherein the mirror housing is attachable to a vehicle via an attachment arm, wherein the mirror housing surrounds and protects the back side of the mirror while leaving the front reflective side visible;
c. an adjustable camera having
i. a lens;
ii. a programable memory and processor; and
iii. a motor operably connected to the lens to adjust a position of the lens, altering a view field of the camera,
wherein the programable memory and processor, and the motor are housed inside the camera compartment,
wherein the lens opening surrounds and holds the lens in place,
wherein the programable memory and processor are operably connected to the one or more built-in signal blinkers so the camera automatically begins to capture a video when the one or more built-in signal blinkers are turned on;
d. a video display portion having a display surface, wherein the mirror is shaped and positioned so as to surround the video display portion on one more sides,
wherein the display surface is operably positioned to form a continuation of the front reflective side of the mirror,
wherein the mirror housing surrounds and encloses the video display portion on any sides not surrounded by the mirror, and
wherein the video display portion is operably connected to the camera to receive the video from the camera and display the video on the display surface.

2. The automatic blind spot mirror and camera system for vehicles according to claim 1, wherein the programable memory and processor are operably connectable to the one or more proximity sensors located on a vehicle body so the camera automatically begins to capture a video when the one or more proximity sensors is triggered.

3. The automatic blind spot mirror and camera system for vehicles according to claim 2, wherein the one or more proximity sensors also include radar detectors, and wherein detecting radar also triggers the one or more proximity sensors.

4. The automatic blind spot mirror and camera system for vehicles according to claim 2, further comprising:
e. a second adjustable camera having
i. a second lens;
ii. a second programable memory and processor;
iii. a second motor operably connected to the second lens to adjust a position of the second lens, altering a view field of the second camera; and
iv. a second camera compartment having a body and a second lens opening,
wherein the second programable memory and processor, and the second motor are housed inside the body of the second camera compartment,
wherein the second lens opening surrounds and holds the lens in place, wherein the second programable memory and processor are operably located at a rear of a vehicle to form a backup camera,
wherein the second programable memory and processor are operably connected to the video display portion to transmit video to display on the display surface,
wherein the second programable memory and processor are operably connected to a gear indicator on the vehicle so that the second adjustable camera automatically begins to capture and transmit video to the video display portion when the vehicle is in a reverse gear.

5. A vehicle and automatic mirror and camera system comprising:
a. a vehicle having a right side, a left side, a front, and a rear; and
b. one or more automatic blind spot camera systems according to claim 1, wherein the mirror and camera system is located on the right side of the vehicle, on the left side of the vehicle, or on the right side of the vehicle and the left side of the vehicle.

6. A vehicle and automatic mirror and camera system comprising:
a. a vehicle having a right side, a left side, a front, and a rear; and
b. one or more automatic blind spot camera systems according to claim 4, wherein one mirror and camera system is located on the right side of the vehicle, and one mirror and camera system is located on the left side of the vehicle.

7. The vehicle and automatic mirror and camera system according to claim 5, wherein the programable memory and processor are operably connectable to the one or more proximity sensors located on a vehicle body so the camera automatically begins to capture a video when the one or more proximity sensors is triggered.

8. The vehicle and automatic mirror and camera system according to claim 7, wherein the one or more proximity sensors also include radar detectors, and wherein detecting radar also triggers the one or more proximity sensors.

9. The vehicle and automatic mirror and camera system according to claim 6, wherein the programable memory and processor are operably connectable to the one or more proximity sensors located on a vehicle body so the camera automatically begins to capture a video when the one or more proximity sensors is triggered.

10. The vehicle and automatic mirror and camera system according to claim 9, wherein the one or more proximity sensors also include radar detectors, and wherein detecting radar also triggers the one or more proximity sensors.
